(19) United States
(12) Patent Application Publication
(10) Pub. No.: US 2021/0074085 A1
(43) Pub. Date: Mar. 11, 2021

(54) VEHICLE DIAGNOSTIC DATA

(71) Applicant: ENT. SERVICES DEVELOPMENT CORPORATION LP, Tysons, VA (US)

(72) Inventors: Jonathan GIBSON, Austin, TX (US); Shivaprasad VENKATRAMAN, Singapore (SG); Joseph MILLER, Herndon, VA (US); Clifford A. WILKE, Herndon, VA (US)

(73) Assignee: ENT. SERVICES DEVELOPMENT CORPORATION LP, Tysons, VA (US)

(21) Appl. No.: 17/087,473

(22) Filed: Nov. 2, 2020

Related U.S. Application Data
(63) Continuation of application No. 15/547,793, filed on Jul. 31, 2017.

(51) Int. Cl. G07C 5/00; G06F 16/29; B60W 50/14; B60W 50/02; G06Q 30/02; B60W 50/00; G01C 21/36

(52) U.S. Cl. CPC G07C 5/008; G06Q 50/01; B60W 50/14; B60W 50/0205; G06Q 30/0207; G06Q 30/0251; G06Q 30/0242; B60W 50/0098; G01C 21/3679; G01C 21/3697; G06Q 30/0239; G06Q 30/0261; G06Q 30/0269; G06Q 30/0277; B60W 2530/20; B60W 2530/145; B60W 2520/105; B60W 2050/143; B60W 2520/10; B60W 2556/50; B60W 2540/26; G06F 16/29

(57) ABSTRACT

In examples provided herein, a system in a vehicle comprises a processor and a memory including instructions executable by the processor to aggregate and transmit to a context-aware platform (CAP) diagnostic data for a vehicle; receive from the CAP responsive information based on analysis of the diagnostic data; and cause the responsive information to be audibly provided to a driver of the vehicle.

### CROSS-REFERENCE TO RELATED APPLICATIONS

This application is a continuation of U.S. application Ser. No. 15/547,793, filed on Jul. 31, 2017, which is a national stage application pursuant to 35 U.S.C. § 371 of International Application No. PCT/US2015/013905, filed Jan. 30, 2015, the disclosure of which is hereby incorporated by reference herein in its entirety.

### BACKGROUND

On-board diagnostics is a computer-based system used in a vehicle to monitor the performance of the vehicle's components. The on-board diagnostics of a vehicle can provide alerts to the driver for a detected problem, such as low fuel, low tire pressure, or low engine oil, by illuminating the corresponding alert lights located on the dashboard of the vehicle. Repair technicians can also retrieve information from the on-board diagnostics system memory when servicing the vehicle to help determine the source of a problem with the vehicle.

### BRIEF DESCRIPTION OF THE DRAWINGS

The accompanying drawings illustrate various examples of the principles described below. The examples and drawings are illustrative rather than limiting.

FIG. 1 depicts an example environment in which a context-aware platform may be implemented, where the context-aware platform analyzes diagnostic data from a vehicle to provide an experience to a driver of the vehicle.

FIG. 2A depicts a schematic illustration of the operation of an example context-aware platform providing an experience to a user, such as a driver of a vehicle.

FIG. 2B depicts a block diagram of example components of a context-aware platform.

FIG. 3A depicts a block diagram of example components of a vehicle diagnostics engine in a vehicle.

FIG. 3B depicts a block diagram depicting an example memory resource and an example processing resource for a vehicle diagnostics engine.

FIG. 4 depicts a flow diagram illustrating an example process of providing an experience to a driver of a vehicle based on vehicle diagnostic data,

FIGS. 5A and 5B depict a flow diagram illustrating an example process of providing an advertisement to a driver of a vehicle based on vehicle diagnostic data.

FIG. 6 depicts a flow diagram illustrating an example process of providing entertainment options to a driver of a vehicle.

FIG. 7 depicts an example system including a processor and non-transitory computer readable medium of a networked device.

FIG. 8 depicts an example system including a processor and non-transitory computer readable medium of a networked device.

### DETAILED DESCRIPTION

As technology becomes increasingly prevalent, it can be helpful to leverage technology to integrate multiple devices, in real-time, in a seamless environment that brings context to information from varied sources without requiring explicit input. Various examples described below provide for a context-aware platform (CAP) that may analyze diagnostic data from a diagnostics module of a vehicle, and based on the analyzed diagnostic data, provide an alert to the driver of the vehicle regarding the condition of the vehicle. Examples of vehicles may include automobiles, trucks, trailers, and recreational vehicles. In some implementations, the CAP may receive location information for the vehicle, and based on the location information and driver preferences, provide an audible advertisement to the driver of the vehicle via a networked device of the driver, such as a smart phone or smart glass. In some instances, the CAP may provide a coupon to the driver, via a networked device, for redeeming at a retail establishment within a predetermined distance of the vehicle. The CAP may also analyze and provide coupon and advertisement effectiveness based upon coupon redemption information.

As used herein, the terms CAP experience and experience are used interchangeably and intended to mean the interpretation of multiple elements of context in the right order and in real-time to provide information in a seamless, integrated, and holistic fashion. In some examples, an experience or CAP experience may be provided to a driver of a vehicle.

The CAP experience is created through the interpretation of one or more packages. Packages can be atomic components that execute functions related to devices or integrations to other systems. As used herein, the term package is intended to mean components that capture individual elements of context in a given situation. In some examples, the execution of packages provides an experience. For example, a diagnostic data analysis package may analyze diagnostic data collected by an on-board vehicle diagnostics engine for a vehicle, and an experience may be provided to the driver of the vehicle by calling the diagnostic data analysis package to determine whether the driver of the vehicle should be alerted regarding a condition of the vehicle, and if so, alerting the driver to the condition. Examples of conditions that the driver may be alerted to include a low fuel level; whether a serviceable condition is present, such as low tire pressure; whether the vehicle is achieving optimum mileage; whether the vehicle is going too fast; and whether the driver is braking too often. Providing feedback to the driver based on the condition of the vehicle allows the driver to service the vehicle, while providing feedback on vehicle performance allows the driver to adjust driving behavior to achieve better or safer vehicle performance.

As another example, if it is determined by the diagnostic data analysis package that the vehicle has a low level of fuel or that vehicle service is recommended to improve vehicle performance, a location mapping package may be called to determine retail establishments that provide the appropriate goods and/or services located within a predetermined distance of the location of the vehicle. Subsequently, an experience may be provided to the driver of the vehicle by providing advertisements and/or coupons to the driver for the identified retail establishments, for example, via a networked device associated with the driver or the driver's vehicle.

In some examples, the CAP includes one or more experiences that may be provided to a driver of a vehicle, and the platform may include a plurality of packages that are accessed by the various experience devices to provide the experiences. The packages may, in turn, access various information from a user or other resources and may call various services, as described in greater detail below. As a result, the user can be provided with contextual information seamlessly with little or no input from the user. The CAP is an integrated ecosystem that can bring context to information automatically. For example, the CAP can sense, retrieve, and provide information from a plurality of disparate sensors, devices, and/or technologies, in context, and without input from a user.

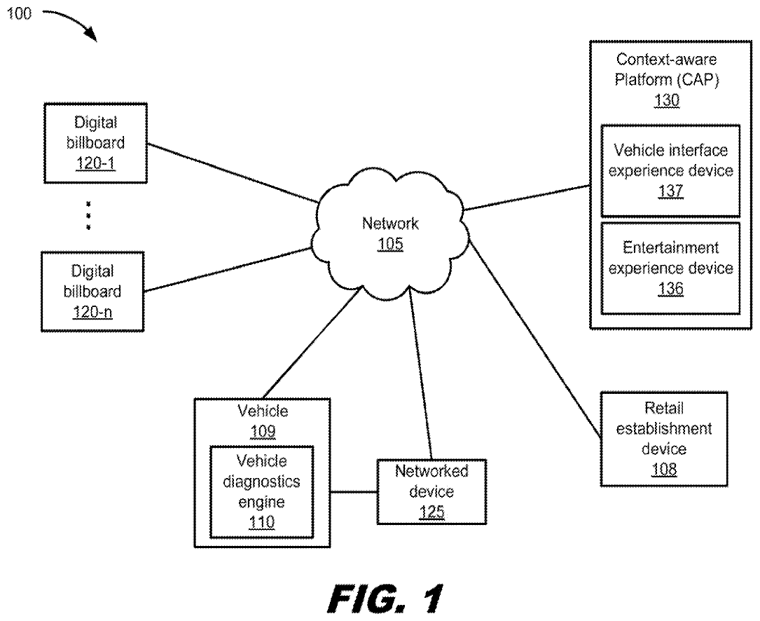

FIG. 1 depicts an example environment 100 in which a context-aware platform (CAP) 130 may be implemented. The CAP 130 may include experience devices, such as a vehicle interface experience device 137 and an entertainment experience device 136, that call various packages to execute functions to provide an experience to a user, such as a driver of a vehicle. As shown in FIG. 1, the CAP 130 may communicate via the network 105 with devices in vehicles 109 (only one is shown in FIG. 1 for clarity), multiple digital billboards 120 (only two are shown in FIG. 1 for clarity), multiple networked devices 125 (only one is shown in FIG. 1 for clarity), and multiple retail establishment devices 108 (only one is shown in FIG. 1 for clarity). The network 105 may be any type of wire or wireless network, such as the Internet, or an intranet.

The vehicle interface experience device 137 of the CAP 130 may cause information to be provided to a driver of a vehicle regarding analyzed diagnostic data collected for the vehicle. Examples of information that may be provided to the driver include location information of a fueling station within a predetermined distance of the vehicle upon determining that the vehicle fuel level is below a threshold level, and location information of a service station within a predetermined distance of the vehicle upon determining that performance of the vehicle does not meet performance criteria.

The entertainment experience device 136 of the CAP 130 may identify the location of retail establishments within a predetermined distance of a vehicle based on received vehicle location information and the types of goods and services offered by the retail establishments to determine advertisements and coupons from appropriate retail establishments to present to a driver of a vehicle based on their preferences. Retail establishments may also include service stations, tourist attractions, entertainment venues, and other places, regardless of whether admission fees are charged.

In the example environment of FIG. 1, vehicles 109 (only one vehicle is shown in FIG. 1 for clarity) may be driven, and the vehicles 109 may include a vehicle diagnostics engine 110, described below, that collects diagnostic data on the performance of the vehicle.

Networked devices 125 may include any number of portable devices associated with the driver of a vehicle that has a processor and memory and is capable of communicating wirelessly by using a wireless protocol, such as WiFi or Bluetooth. Examples of networked devices include a smartphone, tablet, laptop, smart watch, electronic key fob, activity tracking devices, smart glass, and any other device or sensor that can be attached to or worn by a user. Additionally, networked devices 125 may also include devices associated with the vehicle of the driver, such as any device or sensor communicatively coupled to a hotspot of the vehicle that is capable of communicating wirelessly.

Additionally, in the example environment of FIG. 1, one or more networked digital billboards 120-1-120-n may be positioned along a road or a group of roads along which the vehicles 109 are driven. In some implementations, the digital billboards 120 may receive advertisements for display that are targeted to a particular driver of a vehicle along the road where the digital billboard is visible. Also shown in FIG. 1 are retail establishment devices 108 (only one retail establishment device is shown in FIG. 1 for clarity) that may be located at a retail establishment. for example, at a point of sale and integrated with customer relationship management (CRM) systems, to track redemption of electronic coupons provided to the driver of vehicles by the GAP 130.

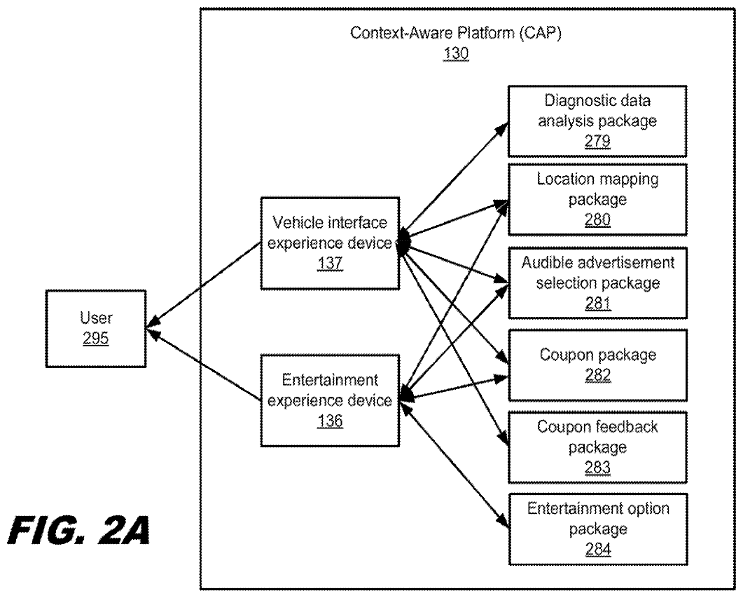

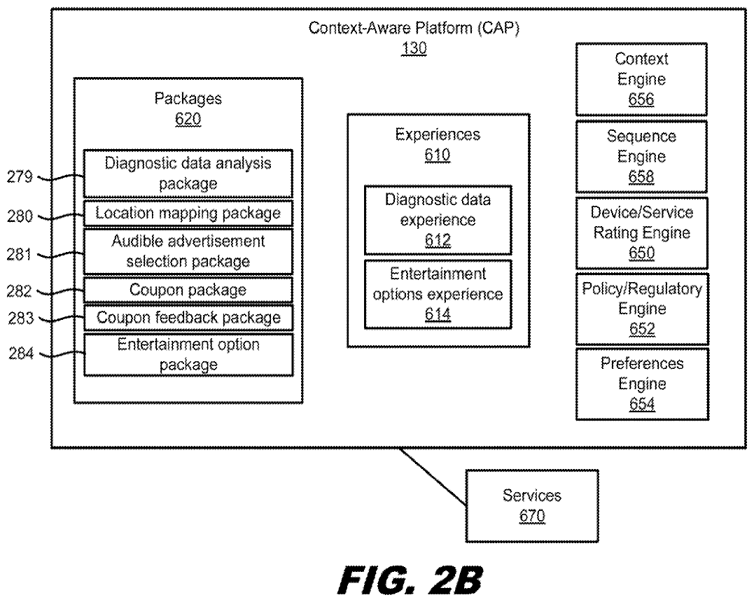

FIG. 2A depicts a schematic illustration of the operation of an example context-aware platform 130 providing an experience to a user 295, such as a driver of a vehicle. In the example of FIG. 2A, the vehicle interface experience device 137 and entertainment experience device 136 may call one or multiple packages, such as diagnostic data analysis package 279, location mapping package 280, audible advertisement selection package 281, coupon package 282, coupon feedback package 283, and entertainment option package 284, to perform their respective functions so that an experience may be provided to the user 295. The vehicle interface experience device 137 and entertainment experience device 136 may represent any circuitry or combination of circuitry and executable instructions to provide an experience to the user 295, and each package may represent any circuitry or combination of circuitry and executable instructions to perform the package's function.

In the example of FIG. 2A, the diagnostic data analysis package 279 may be called to analyze diagnostic data from a vehicle. The diagnostic data may be aggregated and transmitted to the CAP 130 by an onboard diagnostics module or other device of the vehicle, whether or not the device is integrated with the vehicle. The diagnostic data may include, for example, vehicle condition information, such as vehicle fuel or other fluid levels, and engine temperature. Based on the make and model of the vehicle, and past diagnostic data history for the vehicle, the diagnostic data analysis package 279 may determine whether there is currently a problem or an impending problem with the vehicle, such as needing fuel or servicing. Thus, for example, if the fuel level is determined by the diagnostic data analysis package 279 to be low, the driver can be alerted to the low fuel level.

The diagnostic data may include vehicle performance information, such as speed of the vehicle, gas mileage, and acceleration and deceleration of the vehicle. In some implementations, the diagnostic data analysis package 279 may provide recommendations on how to adjust control of the vehicle to improve operational performance of the vehicle. For example, if the gas mileage is lower than expected for the make and model of the car and there are many sudden periods of acceleration and deceleration, the driver may be alerted that slower accelerations of the vehicle may help to improve gas mileage.

In some cases, the diagnostic data may also include driver state data. Driver state data may include vital signs of the driver, such as breathing rate, heart rate, and blood pressure. The driver state data may be received from a networked device associated with the driver, such as a smartphone or other device capable of collecting driver state data. From the driver state data and other vehicle diagnostic data, the diagnostic data analysis package 279 may be able to determine whether the driver may be falling asleep at the wheel. If so, an alert may be sent to the driver to wake the driver up. The alert can be an audible alert, such as a loud sound that can be provided by a networked device or the stereo system of the vehicle. Another type of alert can be strong infrequent vibrations, for example, as provided by a Smart Watch type device that supports such feedback.

The location mapping package 280 may be called to query and receive, from a networked device associated with a driver of a vehicle or the driver's vehicle, a vehicle location. The vehicle location may be provided in any format, such as latitude and longitude coordinates or an address, such as a toll road mile marker. The location mapping package 280 may also identify retail establishments within a predetermined distance of the vehicle location, such as five or ten miles. The location mapping package 280 may use a database to determine the types of goods and/or services provided by each retail establishment within the predetermined distance of the vehicle location. Additionally, the identified retail establishments should meet explicit or implicit preferences of the driver. For example, if the vehicle is low on fuel, the location mapping package 280 may identify a fueling station within a predetermined distance of the vehicle location, or the location mapping package 280 may identify the fueling station with the lowest fuel prices within a predetermined distance of the vehicle, if specified by the driver.

The audible advertisement selection package 281 may be called to identify an audible advertisement for goods and/or services provided by a retail establishment within a predetermined distance of the vehicle location. Retail establishments may provide audible advertisements to be presented to drivers of vehicles within the predetermined distance of the retail establishment. Then each retail establishment may pay a fee each time the retail establishment's audible advertisement is provided to the driver of a vehicle.

The coupon package 282 may be called to identify available electronic coupons for redeeming at the retail establishment. Identified coupons should be configurable to the demographic of drivers and to meet the driver's preferences. A coupon may have an identified expiration time, such as an hour from time of receipt, to encourage the driver to redeem the coupon shortly after notification of transmission of the coupon. In some implementations, electronic payment applications may be used for redeeming the coupons, where the electronic payment applications may use the Internet, mobile/cellular, wireless, or other dedicated communication systems.

The coupon feedback package 283 may be called to perform data analysis on coupon redemption data for the retail establishment. The coupon feedback package 283 may receive coupon redemption information tracked by a retail establishment device at a retail establishment that offers electronic coupons. From the coupon redemption information, advertisements transmitted to drivers, and coupons selected for transmission by the coupon package 282, coupon feedback package 283 may determine coupon and advertisement effectiveness. The coupon and advertisement effectiveness information allows the retail establishments to determine their return on investment (ROI) and to potentially improve their ROI based on targeted advertising.

A driver may want to create a travel experience, for example, by explicitly providing a starting point and a destination, in addition to a list of things the driver wants to see on a trip, such as places to visit, hotels to stay at, and shopping and/or restaurant experiences. The entertainment option package 284 may be called to determine an entertainment option within a predetermined distance of the vehicle location that meets driver preferences. As the driver makes the journey in a vehicle, the CAP 130 may receive the vehicle's location from the driver's networked device. Alternatively, the driver's route may be tracked using a communications network, such as network 105 in FIG. 1, that connects to services like Google Earth or Maps provided by services 670, as shown in FIG. 2B.

Examples of locations of interest that the entertainment option package 284 may identify include music shows; town festivals; local events; historical sites; national, state, and local parks: and theme parks. The locations of interest to be identified may be specified explicitly by the driver, or may be implicitly determined, for example, by performing a social media search performed by preferences engine 654 or services 670.

In some implementations, an experience device calling the entertainment option package 284, such as the entertainment experience device 136, may call other packages if the entertainment option package 284 identifies suitable locations of interest for a user. For example, the entertainment experience device 136 may subsequently cal€ the audible advertisement selection package 281 to identify audible advertisements for the identified locations of interest, and/or the package 282 to identify available coupons for the identified locations of interest.

Thus, for the example of FIG. 2A, experiences that may be provided to a user 295, such as the driver of a vehicle, may include any of the following: determining a location of the vehicle and causing an audible advertisement for a retail establishment to be audibly conveyed to the driver, where the retail establishment may provide goods or services for the vehicle, the retail establishment meets the explicit and implicit preferences of the driver, and the retail establishment is within a predetermined distance of the vehicle; transmitting an electronic coupon to the driver via the driver's networked device for redeeming at a retail establishment and causing a networked device to audibly notify the driver of the transmission of the coupon; providing entertainment options along with applicable audible advertisements and/or coupons to be provided to the driver. Further, an experience may be provided to a person associated with a retail establishment where information from a coupon redemption data analysis is provided.

FIG. 2B depicts a block diagram of example components of an example context-aware platform (CAP) 130. The CAP 130 may determine which package among multiple available packages 279-284 to execute based on information provided by the context engine 656 and the sequence engine 658. In some examples, the context engine 656 may be provided with information from a device/service rating engine 650, a policy/regulatory engine 652, and/or preferences engine 654. For example, the context engine 656 may determine which package to execute based on a device/service rating engine 650 (e.g., hardware and/or program instructions that can provide a rating for devices and/or services based on whether or not a device can adequately perform the requested function, such as the preferred networked device of a plurality of networked devices of the driver to which a coupon is sent), a policy/regulatory engine 652 (e.g., hardware and/or program instructions that can provide a rating based on policies and/or regulations, such as relating to privacy issues), preferences engine 654 (e.g., explicit preferences provided by a user or implicit preferences obtained for the user), or any combination thereof.

Preferences engine 654 may represent any circuitry or combination of circuitry and executable instructions to receive explicit preferences of a user. For example, a vehicle driver may explicitly provide preferences to the CAP 130 about preferred gas and service stations, preferred fuel pricing ranges, gas and service stations that the driver is not interested in patronizing, and preferred restaurants and/or types of food. In some implementations, the preferences engine 654 may determine implicit preferences of the driver. For example, preferences engine 654 may search social media to determine the driver's preferences through blog postings or postings to social media sites. In some implementations, preferences may call an external service, for example services 670, to request that a social media searching service perform the social media search and return the results.

In addition, the sequence engine 658 may communicate with the context engine 656 to identify packages 620 to execute, and to determine an order of execution for the packages 620. In some examples, the context engine 656 may obtain information from the device/service rating engine 650, the policy/regulatory engine 652, and/or preferences engine 654 automatically (e.g., without any input from a user) and may determine what package 620 to execute automatically (e.g., without any input from a user). In addition, the context engine 656 can determine what package 620 to execute based on the sequence engine 658.

In one example, providing a diagnostic data experience 612 to a driver of a vehicle may include calling the diagnostic data analysis package 279 to analyze diagnostic data from a vehicle and provide an alert to the driver as determined from the analysis. The diagnostic data experience 612 may also call the location mapping package 280 to identify the vehicle's location and the audible advertisement selection package 281 to identify an audible advertisement for a retail establishment within a predetermined distance of the vehicle location. Further diagnostic data experience 612 may call the coupon package 282 to identify appropriate coupons for providing to the driver.

In another example, providing an entertainment options experience 614 to a driver may include calling the entertainment option package 284 to identify locations of interest within a predetermined distance of the driver's vehicle that meet the driver's preferences. The entertainment options experience 614 may also call the audible advertisement selection package 281 to identify an audible advertisement for identified locations of interest and/or the coupon package 282 to identify appropriate coupons for the identified locations of interest.

The experiences 612, 614 may be initiated by the driver of a vehicle and received via the driver's networked device which communicates with the CAP system 130 via network 105 (as shown in FIG. 1). Alternatively, when the driver's location is determined to be changing at faster than a walking pace, the experiences 612, 614 may be automatically implemented by the CAP 130.

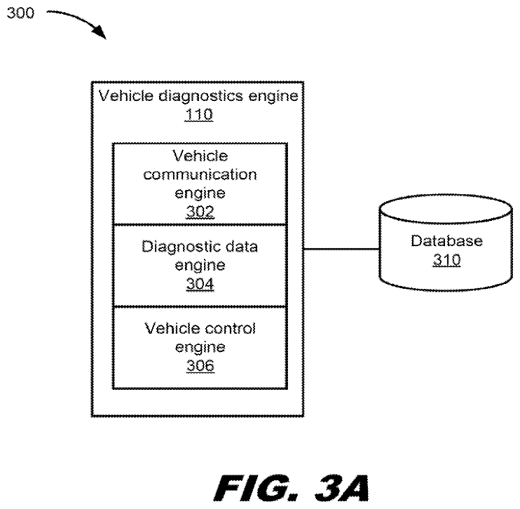

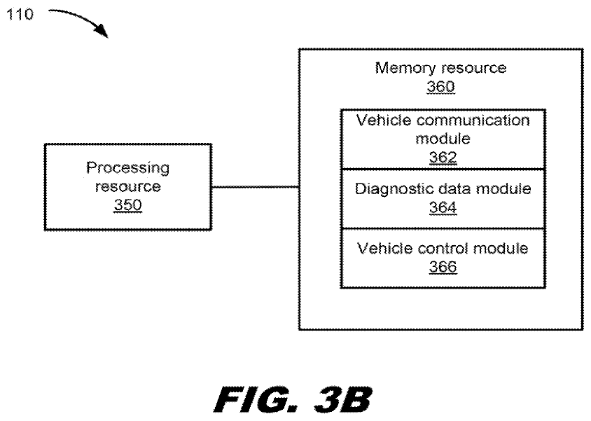

FIG. 3A depicts a block diagram of example components of a vehicle diagnostics engine 110 in a vehicle 109. The vehicle diagnostics engine 110 may include a vehicle communication engine 302, a diagnostic data engine 304, and a vehicle control engine 306. Each of the engines 302-306 may access and be in communication with a database 310.

Vehicle communication engine 302 may represent any circuitry or combination of circuitry and executable instructions to transmit to the CAP diagnostic data collected for a vehicle, where the diagnostic data may include one of vehicle fuel level and vehicle performance information. The vehicle communication engine 302 may also receive from the CAP responsive information based on analysis of the diagnostic data. The responsive information may be based on the diagnostic data and may further be based on location information of the vehicle. For example, the responsive information may include location information of a fueling station within a predetermined distance of the vehicle upon determination by the CAP that the vehicle fuel level is below a threshold level. As another example, the responsive information may include location information of a service station within a predetermined distance of the vehicle upon determination by the CAP from the vehicle performance information that performance of the vehicle does not meet performance criteria.

The vehicle communication engine 302 may receive location information of the vehicle from a networked device of the driver with the functionality to determine location and provide the location information to the CAP along with the diagnostic data. In some implementations, the vehicle communication engine 302 may receive the location information of the vehicle from a device in the vehicle that has the capability to ascertain the location of the vehicle.

In some implementations, the vehicle communication engine 302 may control the vehicle's speakers to audibly provide the responsive information to the driver. Alternatively, the vehicle communication engine 302 may communicate with a networked device communicatively coupled to the vehicle system to cause the networked device to audibly provide to a driver of the vehicle the responsive information. In some implementations, the networked device or even a device in the vehicle controlled by a vehicle control engine 306 may be able to provide physical vibrational feedback, as a mechanism to alert the driver, for example, if the driver is determined by the CAP to be falling asleep.

Moreover, the vehicle communication engine 302 may communicate with a digital billboard 120 to cause an advertisement to be displayed on the digital billboard along a road on which the vehicle is driving. The advertisement may be for a retail establishment providing goods or services related to the responsive information based on analysis of the diagnostic data. Further, the retail establishment may be within a predetermined distance of the vehicle, and the selected retail establishment may be consistent with driver preferences, including implicit and explicit preferences. Explicit preferences may be specified by the driver to the CAP; for example, the driver may use voice commands with a networked smartphone device to provide explicit preferences. In some implementations, the driver's implicit preferences may be determined by the CAP by searching social media for information attributable to the driver. Drivers may be provided an opportunity to opt in and out of permitting implicit preferences to be determined and applied. If drivers opt in to permitting implicit preferences to be determined and applied, the implicit preferences may not override explicit preferences such that implicit references are definable using explicitly specified configurations.

The vehicle communication engine 302 may also receive instructions from the CAP for changing a condition of the vehicle, where the instructions are consistent with the driver's preferences. The instructions are further consistent with social media information obtained by the CAP that is related to a condition of the vehicle based on the diagnostic data.

Diagnostic data engine 304 may represent any circuitry or combination of circuitry and executable instructions to continuously aggregate, monitor, and/or collect diagnostic data about a vehicle, for example by using various sensors within the vehicle to obtain the data. Examples of diagnostic data include vehicle condition, such as fuel level, and vehicle performance information. In some instances, the diagnostic data engine 304 may be communicatively coupled to a driver's networked device that monitors the driver's vital signs, such as breathing rate, blood pressure or heart rate to collect data about the driver's state.

The vehicle control engine 306 may represent any circuitry or combination of circuitry and executable instructions to subsequently change the condition of the vehicle responsive to instructions received from the CAP. For example, if the diagnostic data analyzed by the CAP determines from the driver state data that the driver is falling asleep, the CAP may send instructions for the vehicle control engine 306 to blow cold air from the vehicle's front vents, turn the radio on or louder, roll down the driver's side window for cool air, and/or provide physical vibrational feedback, depending upon the driver's specified preferences. Examples of physical vibrational feedback may include vibrating the seat or a mat in the floor of the car in such a manner as to draw the driver's attention without unduly startling the driver.

Database 310 may contain information used by engines 302-306, such as each driver's preferences and analysis results of received diagnostic data.

The examples of engines, such as shown in FIG. 3A, are not limiting, as the described engines may be combined or may be a sub-engine of another engine. Further, the engines shown can be remote from one another in a distributed computing environment, cloud computing environment, etc.

Various components in the vehicle diagnostics engine 110 of FIG. 3A, may be combinations of hardware and program instructions and implemented in different ways. Referring to FIG. 3B, the programming may be processor executable instructions stored on tangible memory resource 360 and the hardware may include processing resource 350 for executing those instructions. Thus, memory resource 360 may store program instructions that when executed by processing resource 350, implements the vehicle diagnostics engine 110 of FIG. 3A.

Memory resource 360 generally represents any number of memory components capable of storing instructions that can be executed by processing resource 350. Memory resource 360 is non-transitory in the sense that it does not encompass a transitory signal but instead is made up of one or more memory components configured to store the relevant instructions. Memory resource 360 may be implemented in a single device or distributed across devices. Likewise, processing resource 350 represents any number of processors capable of executing instructions stored by memory resource 360, respectively. Processing resource 350 may be integrated in a single device or distributed across devices. Further, memory resource 360 may be fully or partially integrated in the same device as processing resource 350, or it may be separate but accessible to that device and processing resource 350.

In one example, the program instructions can be part of an installation package that when installed can be executed by processing resource 350 to implement vehicle diagnostics engine 110. In this case, memory resource 360 may be a portable computer-readable medium such as a compact disc (CD), digital video disc (DVD), or flash drive or a memory maintained by a server from which the installation package can be downloaded and installed. In another example, the program instructions may be part of an application or applications already installed. Memory resource 360 can include integrated memory, such as a hard drive, solid state drive, or the like.

In the example of FIG. 3B, the executable program instructions stored in memory resource 360 are depicted as vehicle communication module 362, diagnostic data module 364, and vehicle control module 366. Vehicle communication module 362 represents program instructions that when executed cause processing resource 350 to implement vehicle communication engine 302. Diagnostic data module 364 represents program instructions that when executed cause processing resource 350 to implement diagnostic data engine 304. Vehicle control module 366 represents program instructions that when executed cause processing resource 350 to implement vehicle control engine 306.

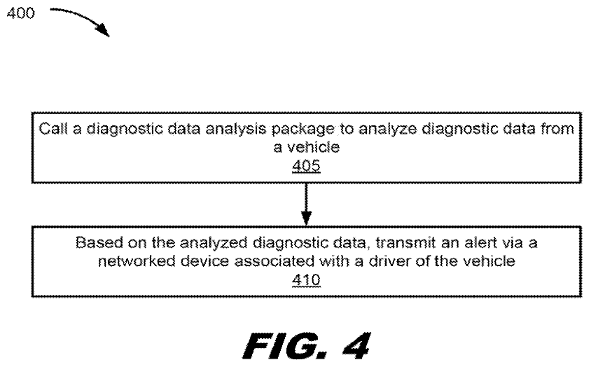

FIG. 4 depicts a flow diagram illustrating an example process 400 of providing an experience to a driver of a vehicle that provides feedback on vehicle diagnostic data. The process begins at block 405 where the CAP may call a diagnostic data analysis package to analyze diagnostic data from a vehicle. The diagnostic data may include vehicle condition information, vehicle performance information and/or driver state data.

At block 410, the CAP may transmit an alert via a networked device based on the analyzed diagnostic data. The networked device may be directly associated with a driver of the vehicle, or indirectly associated with the driver through the driver's vehicle. The alert may be provided audibly to the driver by the networked device. As the driver is occupied driving and is not able to read the information, the networked device should have a speaker or other device that can audibly provide the information to the user. The alert may include location information of a fueling station within a predetermined distance of the vehicle upon determination by the CAP that the vehicle fuel level is below a threshold level, or location information of a service station within a predetermined distance of the vehicle upon determination by the CAP from the vehicle performance information that vehicle service is beneficial for the vehicle. An example of the information provided to the driver in the first case is your vehicle is low on fuel; and your fuel level will allow you to drive to the next gas station two exits away; also, here is a coupon for a car wash at that gas station.” The selection of a fueling station or a service station may be based on the driver's implicit preferences or explicit preferences.

If the alert pertains to operation of the vehicle, the alert may indicate that the driver's driving behavior should be adjusted, for example, to increase the performance of the vehicle, or to drive in a safer manner.

In some implementations, the networked device may also be in communication with a vehicle control device. Thus, if the diagnostic data indicate that the driver is falling asleep, an alert may be transmitted to the networked device, and the networked device may prompt the vehicle control device to blow cold air from the vehicle's front vents, turn the radio on or louder; roll down the driver's side window for cool air, and/or provide physical vibrational feedback, depending upon the driver's specified preferences.

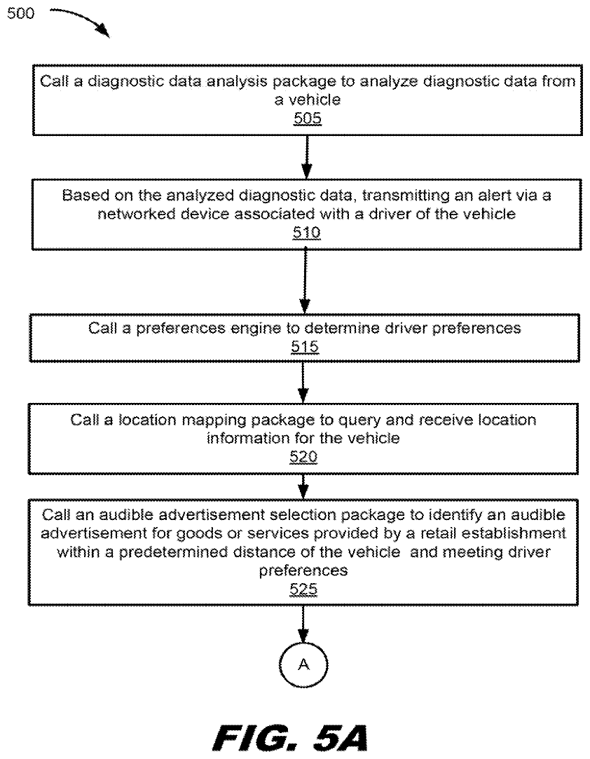

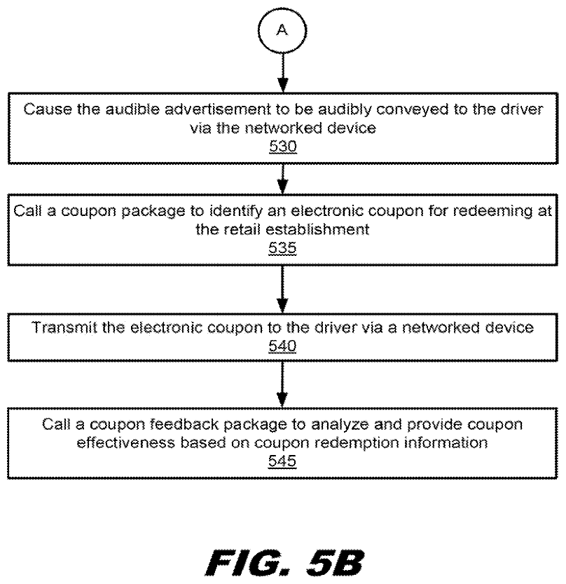

FIG. 5 depicts a flow diagram illustrating an example process 500 of providing an advertisement to a driver of a vehicle based on vehicle diagnostic data. The process begins at block 505 which may be similar to block 405 described with respect to the process 400 of FIG. 4. Block 510 may also be similar to block 410 of FIG. 4.

At block 515, the CAP may call a preferences engine to determine a driver's explicit and implicit preferences. The driver's implicit preferences may be determined by searching social media sites. Alternatively, the preferences engine may call an external service to request that a social media searching service perform the social media search and return the results.

At block 520, the CAP may call a location mapping package to query and receive location information for the vehicle. The location information may, for example, be received from a networked device of the driver, such as a smartphone that may be running a GPS program that can determine the location of smartphone, and thus, the vehicle.

At block 525, the CAP may call an audible advertisement selection package to identify an audible advertisement for goods or services provided by a retail establishment within a predetermined distance of the vehicle and meeting driver preferences. The goods or services may be relevant to an analysis of the diagnostic data from the vehicle.

At block 530, the CAP may cause the audible advertisement to be audibly conveyed to the driver via a networked device associated with the driver or the driver's vehicle.

At block 535, the CAP may call a coupon package to identify an electronic coupon for redeeming at the retail establishment to entice the driver to patronize the retail establishment. The coupon may have an expiration time associated with it to encourage the driver to redeem the coupon as soon as possible. And at block 540, the CAP may transmit the electronic coupon to the driver via a networked device.

At block 545, the CAP may call a coupon feedback package to analyze and provide coupon effectiveness based on coupon redemption information. A driver may redeem an electronic coupon at a participating retail establishment, for example, by using an electronic payment application, and the retail establishment may have a retail establishment device that tracks the redemption of the electronic coupons provided by CAP. The retail establishment device may record the date and/or time of redemption of a coupon, coupon identification information, and items that the driver of the vehicle purchased when redeeming the coupon. This information may be analyzed to provide coupon effectiveness.

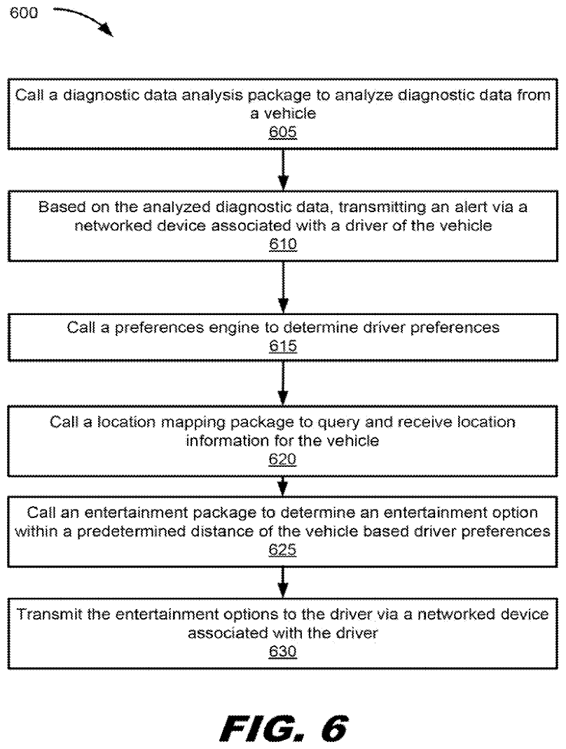

FIG. 6 depicts a flow diagram illustrating an example process 600 of providing entertainment options to a driver of a vehicle. The process begins at block 605 which may be similar to block 405 described with respect to the process 400 of FIG. 4. Block 610 may also be similar to block 410 of FIG. 4. Block 615 may be similar to block 515 described with respect to the process 500 of FIG. 5, and block 620 may also be similar to block 520 of FIG. 5.

At block 625, the CAP may call an entertainment package to determine entertainment options within a predetermined distance of the vehicle based on driver preferences. Entertainment options should be within a predetermined distance of the location of the vehicle, where the predetermined distance may be explicitly specified by the driver. The entertainment options should also meet the driver's explicit and implicit preferences.

At block 630, the CAP may transmit the identified entertainment options to the driver via a networked device associated with the driver. The networked device may audibly provide the entertainment options to the driver.

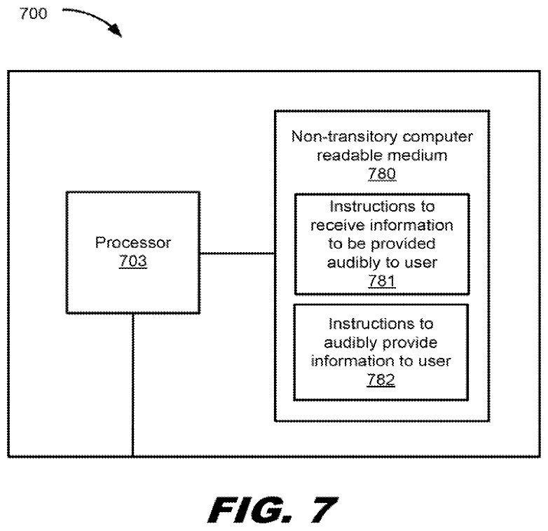

FIG. 7 illustrates an example system 700 including a processor 703 and non-transitory computer readable medium 780 according to the present disclosure. For example, the system 700 may be an implementation of an example system such as a networked device 125 of FIG. 1.

The processor 703 may execute instructions stored on the non-transitory computer readable medium 780. For example, the non-transitory computer readable medium 780 may be any type of volatile or non-volatile memory or storage, such as random access memory (RAM), flash memory, or a hard disk. When executed, the instructions can cause the processor 703 to perform a method of receiving and audibly providing information to a user.

The example medium 780 can store instructions 781 executable by the processor 703 to receive information to be provided audibly to a user. For example, the processor 703 can execute instructions 781 to receive information to be audibly provided to a user. The information may include alerts pertaining to the vehicle, as determined from diagnostic data, an alert to wake the driver up, advertisements for goods and/or services, coupons for redeeming at a retail establishment, and/or entertainment options within a predetermined distance of the vehicle that meets the driver's preferences.

The example medium 780 can further store instructions 782. The instructions may be executable by the processor 703 to audibly provide the information to the user. The networked device may use its own speakers to audibly provide the advertisement to the driver. Alternatively, the networked device may communicate with another networked device associated with the driver, such as a vehicle control device to play the advertisement over the vehicle's speakers.

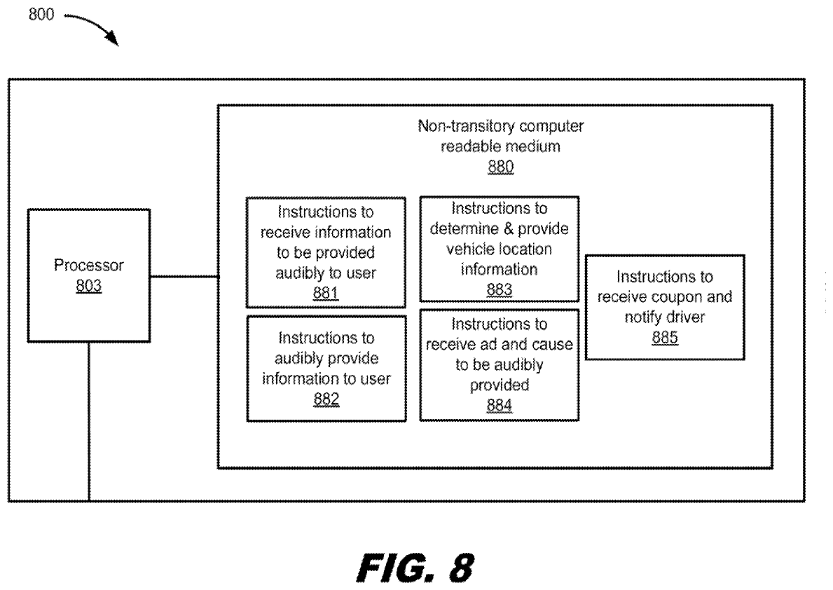

FIG. 8 illustrates an example system 800 including a processor 803 and non-transitory computer readable medium 880 according to the present disclosure. For example, the system 800 can be an implementation of an example system such as a networked device 125 of FIG. 1.

The processor 803 may execute instructions stored on the non-transitory computer readable medium 880. For example, the non-transitory computer readable medium 880 may be any type of volatile or non-volatile memory or storage, such as random access memory (RAM), flash memory, or a hard disk. When executed, the instructions can cause the processor 803 to perform a method of providing an experience to a user who is a driver of a vehicle in conjunction with a context-aware platform.

Instructions 881 may be similar to instructions 781 described with respect to the non-transitory computer readable medium 780 of FIG. 7. Instructions 882 may also be similar to instructions 782 of FIG. 7.

The example medium 880 may store instructions 883 executable by the processor 803 to determine and provide vehicle location information.

The example medium 880 may further store instructions 884 executable by the processor 803 to receive an advertisement from the CAP and cause the advertisement to be audibly provided to the driver. The networked device may use its own speakers to audibly provide the advertisement to the driver. Alternatively, the networked device may communicate with another networked device associated with the driver, such as a vehicle control device to play the advertisement over the vehicle's speakers.

The example medium 880 may also store instructions 885 executable by the processor 803 to electronically receive a coupon from the CAP and notify the driver of receipt of the coupon.

Not all of the steps, features, or instructions presented above are used in each implementation of the presented techniques. Elements shown in the various figures described above can be added, exchanged, and/or eliminated so as to provide a number of additional examples of the present disclosure.

1. A system in a vehicle comprising;
a processor;
a memory including instructions executable by the processor to:
initiate a context-aware platform (CAP) based on a determination that a location of a driver of the vehicle is changing;
aggregate and transmit to the CAP diagnostic data for the vehicle;
receive from the CAP responsive information based on analysis of the diagnostic data;
cause the responsive information to be provided to the driver of the vehicle;
receive explicit preferences provided by the driver to the CAP, the explicit preferences including first driver preferences identifying preferred retail establishments, and second driver preferences identifying retail establishments that the driver is not interested in patronizing;
provide location information of the vehicle to the CAP; and
cause an advertisement related to the responsive information to be displayed on a digital billboard along a road on which the vehicle is located;
wherein the advertisement is for a retail establishment providing goods or services related to the responsive information; and
wherein the retail establishment is consistent with the first and second driver preferences.

2. The system of claim 1:
further wherein the retail establishment is within a predetermined distance of the vehicle.

3. The system of claim 2,
wherein the retail establishment is consistent with implicit preferences associated with the driver, and
wherein the implicit preferences are determined by the CAP by searching social media for information attributable to the driver.

4. The system of claim 1, wherein the memory includes instructions further executable by the processor to:
provide location information of the vehicle to the CAP,
wherein the diagnostic data includes a vehicle fuel level, and further wherein the responsive information includes location information of a fueling station within a predetermined distance of the vehicle upon determination by the CAP that the vehicle fuel level is below a threshold level, and
wherein the diagnostic data includes vehicle performance information, and further wherein the responsive information includes location information of a service station within a predetermined distance of the vehicle upon determination by the CAP from the vehicle performance information that vehicle service is recommended.

5. The system of claim 1, wherein the memory includes instructions executable by the processor to:
aggregate and transmit to the CAP driver state data;
receive instructions from the CAP for changing a condition of the vehicle upon determination by the CAP from the driver state data that the driver of the vehicle is failing asleep, wherein the instructions from the CAP are consistent with the driver's preferences, and
change the condition of the vehicle responsive to the instructions.

6. The system of claim 1, wherein the diagnostic data includes vehicle operation information, and wherein the responsive information includes a recommendation to modify vehicle operation.

7. A non-transitory computer-readable medium having instructions stored thereon, the instructions executable by a processor of a networked device associated with a driver of a vehicle comprising:
determine that a location of the driver of the vehicle is changing;
receive vehicle information to be provided to the driver,
wherein the vehicle information is based on diagnostic data received from a diagnostics module of the vehicle that collects the diagnostic data about the vehicle;
provide the vehicle information to the driver;
receive explicit preferences provided by the driver, the explicit preferences including first driver preferences identifying preferred retail establishments, and second driver preferences identifying retail establishments that the driver is not interested in patronizing;
determine and provide location information for the vehicle;
receive an advertisement for a retail establishment providing goods or services related to the vehicle information, wherein the retail establishment is within a predetermined distance of the vehicle; and
cause the advertisement to be displayed on a digital billboard along a road on which the vehicle is located;
wherein the advertisement is for the retail establishment; and
wherein the retail establishment is consistent with the first and second driver preferences.

8. The non-transitory computer-readable medium of claim 7,
wherein the vehicle information includes 1) location information of a fueling station within a predetermined distance of the vehicle upon determination by the CAP from the diagnostic data that the vehicle fuel level is below a threshold level, or 2) location information of a service station within a predetermined distance of the vehicle upon determination by the CAP from the diagnostic data that vehicle service is recommended to improve performance of the vehicle, and
further wherein the fueling station or the service station is based on the implicit preferences, the explicit preferences, and/or social media information.

9. The non-transitory computer-readable medium of claim 7, wherein the instructions are executable by the processor of the networked device and further comprising:
receive from the CAP an electronic coupon for the driver, wherein the coupon is for goods or services related to the received information provided by a retail establishment within a predetermined distance of the vehicle; and
notify the driver of availability of the coupon for redemption.

10. The non-transitory computer-readable medium of claim 9, wherein the coupon is based upon the implicit or explicit preferences of the driver.

11. A method comprising:
determining that a location of a driver of a vehicle is changing
calling a diagnostic data analysis package to analyze diagnostic data from the vehicle; and
based on the analyzed diagnostic data, transmitting an alert via a networked device associated with the driver of the vehicle,
wherein the alert is provided to the driver by the networked device;
calling a preferences engine to determine explicit preferences provided by the driver, the explicit preferences including first driver preferences identifying preferred retail establishments, and second driver preferences identifying retail establishments that the driver is not interested in patronizing;
calling a location mapping package to query and receive location information for the vehicle;
calling an advertisement selection package to identify an advertisement for goods or services provided by a retail establishment within a predetermined distance of the vehicle and meeting driver preferences; and
causing the advertisement to be displayed on a digital billboard along a road on which the vehicle is located;
wherein the advertisement is for the retail establishment; and
wherein the retail establishment is consistent with the first and second driver preferences.

12. The method of claim 11, further comprising:
calling a coupon package to identify an electronic coupon for redeeming at the retail establishment;
transmitting the electronic coupon to the driver via a networked device; and
calling a coupon feedback package to analyze and provide coupon effectiveness based on coupon redemption information.

13. The method of claim 11, further comprising:
calling a preferences engine to determine the explicit preferences;
calling a location mapping package to query and receive location information for the vehicle;
calling an entertainment package to determine an entertainment option within a predetermined distance of the vehicle that meets the explicit preferences; and
transmitting the entertainment options to the driver via a networked device associated with the driver.

14. The system of claim 1, wherein the responsive information includes at least a recommendation to improve gas mileage.

15. The medium of claim 7, wherein the vehicle information includes at least a recommendation to improve gas mileage.

16. The method of claim 11, wherein the alert includes at least a recommendation to improve gas mileage.

17. The system of claim 5, wherein the driver state data includes one or more of: vital signs of the driver, a breathing rate of the driver, a heart rate of the driver, or a blood pressure of the driver.

18. The system of claim 5, wherein the change the condition of the vehicle includes one or more of: blow cold air from the front vents of the vehicle, adjust a volume of a radio of the vehicle, open a driver's side window, or provide physical vibrational feedback.
